(19) United States
(12) Patent Application Publication
(10) Pub. No.: US 2022/0216771 A1
(43) Pub. Date: Jul. 7, 2022

(54) DRIVE DEVICE

(71) Applicant: NIDEC CORPORATION, Kyoto (JP)

(72) Inventor: Shota KAWASHIMA, Kyoto (JP)

(21) Appl. No.: 17/603,947

(22) PCT Filed: Apr. 14, 2020
(86) PCT No.: PCT/JP2020/016430

§ 371 Date: Oct. 15, 2021

(30) Foreign Application Priority Data
Apr. 19, 2019 (JP) 2019-080351

(51) Int. Cl. H02K 11/33; H02K 11/25; B60K 17/22; B60K 17/04; H02K 9/19; H02K 3/50; H02P 27/06

(52) U.S. Cl. CPC H02K 11/33; H02K 11/25; B60K 17/22; H02K 2203/09; H02K 9/19; H02K 3/50; H02P 27/06; B60K 17/04

(57) ABSTRACT

A drive device rotating an axle of a vehicle includes: a motor having a rotor and a stator; a housing; a temperature sensor for detecting a temperature of the motor; and an oil passage supplying oil to the stator from above. The stator includes a stator core and a coil assembly having coils attached to the stator core. The coil assembly has a terminal portion located on one side of the motor axis in a predetermined direction orthogonal to both the axial direction and the vertical direction. The temperature sensor is in a portion of the coil assembly on one side in the predetermined direction with respect to the motor axis. The temperature sensor is on a lower side with respect to the terminal portion and an upper side with respect to an end on a lower side in the vertical direction with respect to the rotor.

### CROSS-REFERENCE TO RELATED APPLICATIONS

This is the U.S. national stage of application No. PCT/JP2020/016430, filed on Apr. 14, 2020, and priority under 35 U.S.C. § 119(a) and 35 U.S.C. § 365(b) is claimed from Japanese Patent Application No. 2019-080351, filed on Apr. 19, 2019.

### FIELD OF THE INVENTION

The present invention relates to a drive device.

### BACKGROUND

A drive device including a motor and rotating an axle of a vehicle is known. For example, as such a drive device, a rear transaxle that drives rear wheels is known.

In the drive device as described above, for example, in order to cool the motor and drive the drive device with energy efficiency, it is required to accurately detect the highest temperature among the temperatures of the motor.

### SUMMARY

One aspect of a drive device of the present invention is a drive device that rotates an axle of a vehicle. The drive device includes: a motor including a rotor rotatable about a motor axis extending in a direction orthogonal to a vertical direction and a stator surrounding the rotor; a housing having a motor housing that houses the motor therein; a temperature sensor capable of detecting a temperature of the motor; and an oil passage that supplies oil to the stator from above in the vertical direction in the motor housing. The stator includes: a stator core; and a coil assembly having a plurality of coils attached to the stator core. The coil assembly includes a terminal portion located on one side of the motor axis in a predetermined direction orthogonal to both an axial direction and a vertical direction of the motor axis. The temperature sensor is provided in a portion of the coil assembly located on one side in the predetermined direction with respect to the motor axis, and is located on a lower side in the vertical direction with respect to the terminal portion and on an upper side in the vertical direction with respect to an end on a lower side in the vertical direction of the rotor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram illustrating a schematic structure of a drive device according to the present embodiment;

FIG. 2 is a perspective view illustrating the drive device according to the present embodiment;

FIG. 3 is a cross-sectional view of a portion illustrating the drive device of the present embodiment taken along line III-III in FIG. 2;

FIG. 4 is a perspective view illustrating a portion of the drive device according to the present embodiment;

FIG. 5 is a perspective view illustrating a portion of a stator of the present embodiment;

FIG. 6 is a perspective view illustrating a portion of a motor of the present embodiment;

FIG. 7 is a view of a portion of the motor of the present embodiment as viewed from the upper side;

FIG. 8 is a perspective view illustrating a second reservoir of the present embodiment;

FIG. 9 is a cross-sectional view illustrating a portion of the motor of the present embodiment taken along line IX-IX in FIG. 7;

FIG. 10 is a cross-sectional view illustrating a portion of the motor of the present embodiment taken along line X-X in FIG. 7;

FIG. 11 is a side view illustrating a motor of a first modification; and

FIG. 12 is a side view illustrating a motor of a second modification.

### DETAILED DESCRIPTION

In the following description, the vertical direction is defined and described based on the positional relationship when a drive device 1 of an embodiment illustrated in each drawing is mounted on a vehicle located on a horizontal road surface. In addition, in the drawings, an XYZ coordinate system is illustrated appropriately as a three-dimensional orthogonal coordinate system. In the XYZ coordinate system, a Z-axis direction is the vertical direction. A+Z side corresponds to an upper side in the vertical direction, while a −Z side corresponds to a lower side in the vertical direction. In the following description, the upper side and the lower side in the vertical direction will be referred to simply as the “upper side” and the “lower side”, respectively. An X-axis direction is a direction orthogonal to the Z-axis direction and is a front-rear direction of a vehicle on which a drive device is mounted. In the embodiment below, a +X side is a front side of a vehicle, and a −X side is a rear side of the vehicle. A Y-axis direction is a direction orthogonal to both the X-axis direction and the Z-axis direction, and is a left-right direction of the vehicle, or a vehicle lateral direction. In the embodiment below, a +Y side is a left side of a vehicle, and a −Y side is a right side of the vehicle. Each of the front-rear direction and the left-right direction is a horizontal direction perpendicular to the vertical direction. In the present embodiment, the front-rear direction corresponds to a predetermined direction. In the present embodiment, the rear side corresponds to one side in a predetermined direction, and the front side corresponds to the other side in the predetermined direction.

The positional relationship in the front-rear direction is not limited to the positional relationship in the embodiment below, and thus the +X side may be the rear side of a vehicle, and the −X side may be the front side of the vehicle. In this case, the +Y side is the right side of the vehicle, and the −Y side is the left side of the vehicle.

Each drawing appropriately illustrates a motor axis J1 that extends in the Y-axis direction, i.e., the left-right direction of a vehicle. In the following description, unless otherwise specified, a direction parallel to the motor axis J1 is simply referred to as an “axial direction”, a radial direction around the motor axis J1 is simply referred to as a “radial direction”, and a circumferential direction about the motor axis J1, i.e., about the motor axis J1, is simply referred to as a “circumferential direction”. In the present specification, a “parallel direction” includes a substantially parallel direction, and an “orthogonal direction” includes a substantially orthogonal direction.

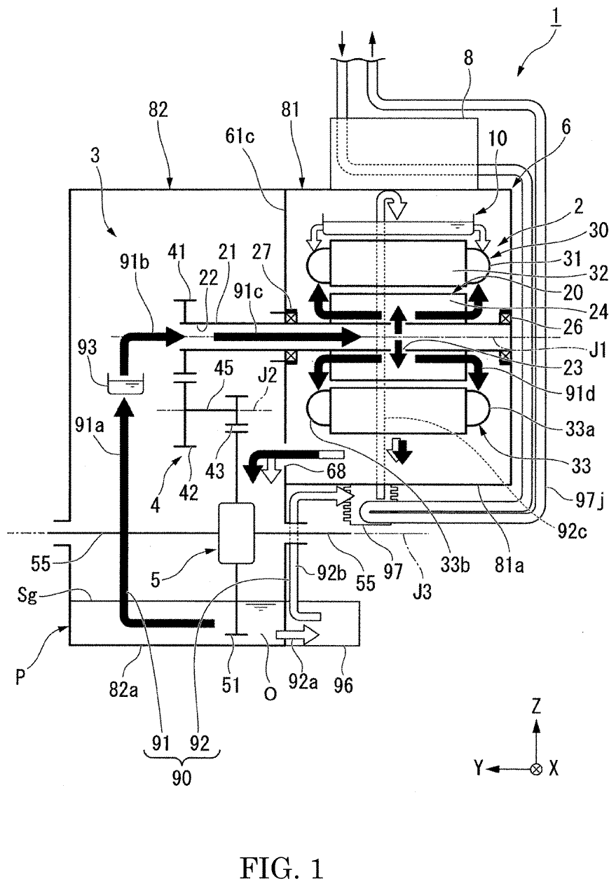

The drive device 1 according to the present embodiment illustrated in FIG. 1 is installed in a vehicle having a motor as a power source, such as, for example, a hybrid electric vehicle (HEV), a plug-in hybrid vehicle (PHV), or an electric vehicle (EV), and is used as the power source thereof. As illustrated in FIG. 1, the drive device 1 includes a housing 6, an inverter unit 8, a motor 2, and a transmission device 3. The transmission device 3 includes a speed reducer 4 and a differential 5. That is, the drive device 1 includes the speed reducer 4 and the differential 5.

The housing 6 includes a motor housing 81, a gear housing 82, and a partition 61c. The motor housing 81 is a portion for housing a rotor 20 and a stator 30 inside described later. The gear housing 82 is a portion that houses the transmission device 3 inside. The gear housing 82 is located on the left side (+Y side) of the motor housing 81. A bottom 81a of the motor housing 81 is located higher than a bottom 82a of the gear housing 82. The partition 61c partitions the inside of the motor housing 81 and the inside of the gear housing 82 from each other in the axial direction. The partition 61c includes a partition opening 68. The partition opening 68 connects the inside of the motor housing 81 and the inside of the gear housing 82.

Oil O is stored in the motor housing 81 and the gear housing 82. The gear housing 82 is provided in its inner lower region with an oil pool P in which the oil O accumulates. The oil O in the oil pool P is fed to the inside of the motor housing 81 through an oil passage 90 described later. The oil O fed to the inside of the motor housing 81 accumulates in an inner lower region of the motor housing 81. At least some of the oil O having accumulated inside the motor housing 81 moves to the gear housing 82 through the partition opening 68 and returns to the oil pool P.

Note that, when an oil is herein described as being housed in a specific portion, it means that the oil is located in the specific portion at least at one time while the motor is in operation, and the oil may not be located in the specific portion when the motor is at rest. For example, in the present embodiment, “the oil O is contained inside the motor housing 81” means that the oil O is located inside the motor housing 81 at least partly during driving of the motor 2. When the motor 2 is stopped, all the oil O in the motor housing 81 may move to the gear housing 82 through the partition opening 68. In addition, some of the oil O fed to the inside of the motor housing 81 through the oil passage 90 described later may remain inside the motor housing 81 when the motor 2 is stopped.

The oil O is arranged to circulate through the oil passage 90, which will be described below. The oil O is used to lubricate the speed reducer 4 and the differential 5. In addition, the oil O is also used to cool the motor 2. An oil equivalent to a lubricating oil for an automatic transmission (ATF: Automatic Transmission Fluid) having a relatively low viscosity is preferably used as the oil O so that the oil O can perform functions of a lubricating oil and a cooling oil.

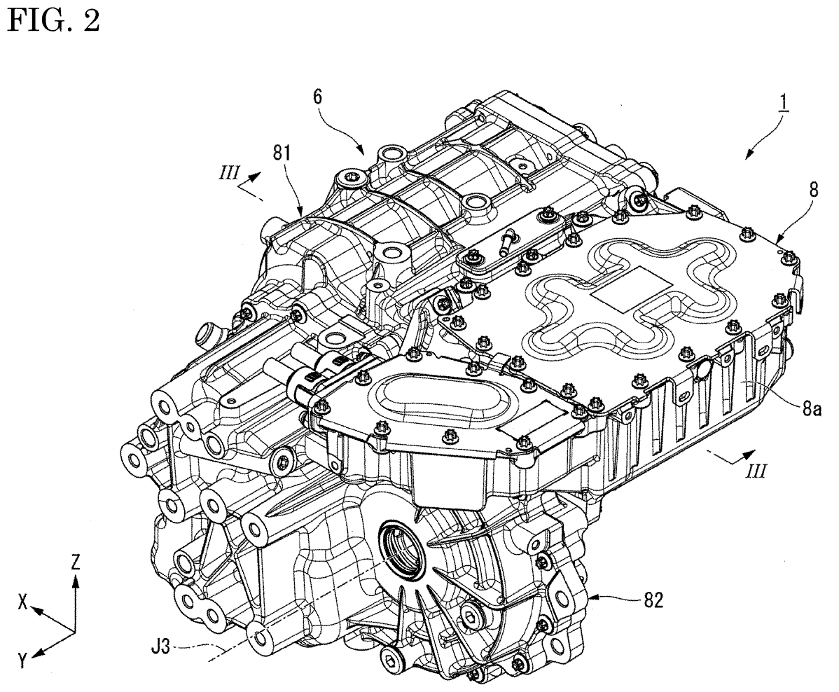

The bottom 82a of the gear housing 82 is located below the bottom 81a of the motor housing 81. This allows the oil O sent from the gear housing 82 to the motor housing 81 to easily flow into the gear housing 82 through the partition opening 68. As illustrated in FIG. 2, the gear housing 82 extends in the front-rear direction. The gear housing 82 is connected at its front (+X side) end to a left (+Y side) end of the motor housing 81. The gear housing 82 has a rear (−X side) end protruding rearward from the motor housing 81.

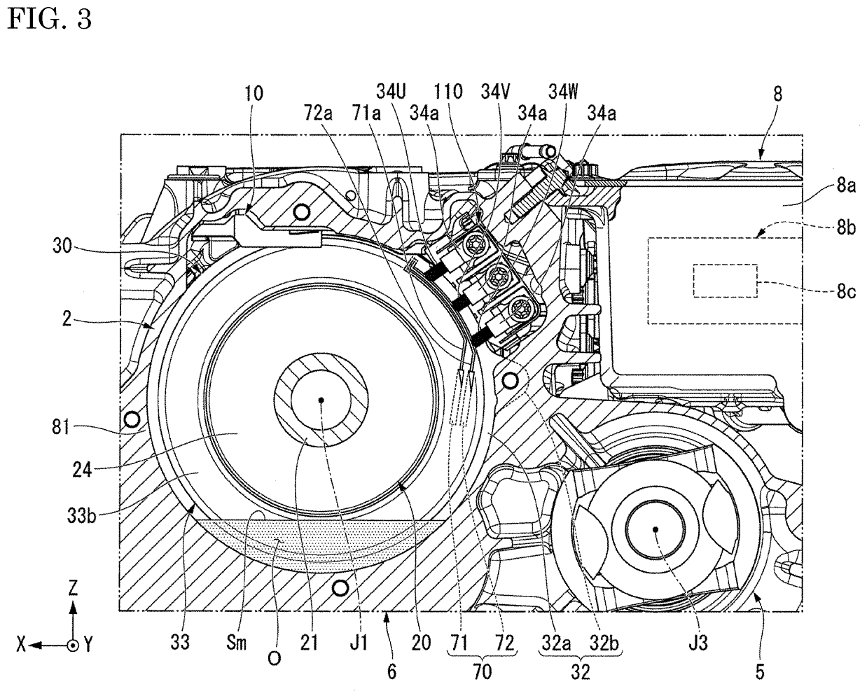

The inverter unit 8 is located on the rear side (−X side) of the motor housing 81. The inverter unit 8 has a substantially rectangular parallelepiped shape elongated in the axial direction. The end on the left side (+Y side) of the inverter unit 8 is located above a portion of the gear housing 82 protruding rearward from the motor housing 81. As illustrated in FIG. 3, the inverter unit 8 is located on the rear side of the motor 2. The inverter unit 8 includes an inverter case 8a and a control unit 8b.

The inverter case 8a has a substantially rectangular parallelepiped box shape elongated in the axial direction. The inverter case 8a is attached to the rear side (−X side) of the motor housing 81 with, for example, a screw. The control unit 8b controls the motor 2 and an oil pump 96 to be described later. More specifically, the control unit 8b controls the motor 2 and the oil pump 96 based on a detection result of a temperature sensor 70 described later. The control unit 8b is housed inside the inverter case 8a. The control unit 8b includes an inverter 8c that supplies power to the motor 2. That is, the inverter unit 8 includes the inverter 8c.

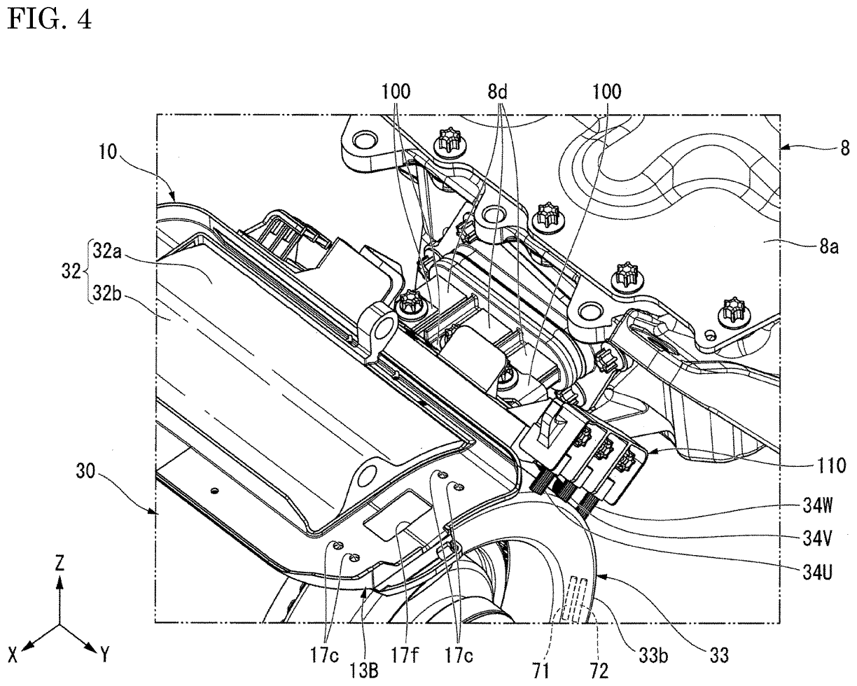

As illustrated in FIG. 4, the inverter unit 8 includes a second busbar 8d protruding forward from a wall portion on the front side (+X side) of the inverter case 8a. The second busbar 8d penetrates the front wall portion of the inverter case 8a in the front-rear direction. Although not illustrated, a portion of the second busbar 8d located inside the inverter case 8a is electrically connected to the inverter 8c. For example, three second busbars 8d are provided. The three second busbars 8d are arranged side by side at intervals in the front-rear direction.

In the present embodiment, the motor 2 is an inner-rotor motor. As illustrated in FIG. 1, the motor 2 includes a rotor 20, a stator 30, and bearings 26 and 27. The rotor 20 is arranged to be capable of rotating about a motor axis J1, which extends in a horizontal direction orthogonal to the vertical direction. A torque of the rotor 20 is transferred to the transmission device 3. The rotor 20 includes a shaft 21 and a rotor body 24. Although not illustrated in the drawings, the rotor body 24 includes a rotor core, and a rotor magnet fixed to the rotor core.

As illustrated in FIG. 3, the lower end of the rotor body 24 is located above an oil level Sm of the oil O stored in the motor housing 81. Therefore, when the rotor 20 rotates, it is possible to suppress the oil O stored inside the motor housing 81 from becoming a resistance. The lower end of the rotor body 24 is the lower end of the rotor 20.

As illustrated in FIG. 1, the shaft 21 is arranged to extend in the axial direction with the motor axis J1 as a center. The shaft 21 is arranged to rotate about the motor axis J1. The shaft 21 is a hollow shaft including a hollow portion 22 defined therein. The shaft 21 includes a communicating hole 23. The communicating hole 23 is arranged to extend in a radial direction to connect the hollow portion 22 to a space outside of the shaft 21.

The shaft 21 extends across the motor housing 81 and the gear housing 82 of the housing 6. The end of the shaft 21 on the left side (+Y side) is arranged to protrude into the gear housing 82. A first gear 41, which will be described below, of the transmission device 3 is fixed to the end of the shaft 21 on the left side. The shaft 21 is rotatably supported by the bearings 26 and 27.

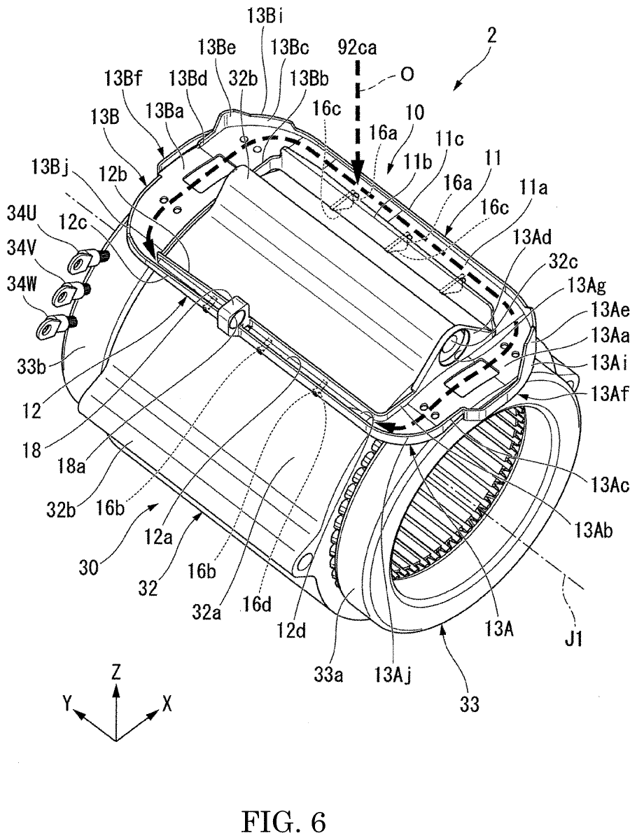

The stator 30 is arranged radially opposite to the rotor 20 with a gap therebetween. In more detail, the stator 30 is located radially outside of the rotor 20. The stator 30 surrounds the rotor 20. The stator 30 includes a stator core 32 and a coil assembly 33. The stator core 32 is fixed to an inner peripheral surface of the motor housing 81. Referring to FIGS. 3 and 6, the stator core 32 includes a stator core body 32a and a fixing portion 32b. Although not illustrated, the stator core body 32a includes a cylindrical core back extending in the axial direction, and a plurality of teeth extending radially inward from the core back.

The fixing portion 32b is arranged to protrude radially outward from an outer circumferential surface of the stator core body 32a. The fixing portion 32b is a portion fixed to the motor housing 81. As illustrated in FIG. 6, a plurality of the fixing portions 32b is provided at intervals along the circumferential direction. One of the fixing portions 32b is arranged to protrude upward from the stator core body 32a. The other one of the fixing portions 32b is arranged to protrude rearward (i.e., the −X side) from the stator core body 32a. The fixing portion 32b includes a through hole 32c arranged to penetrate the fixing portion 32b in the axial direction. The stator 30 is fixed to the housing 6 by tightening a screw passing through the through hole 32c into the motor housing 81.

Referring to FIG. 1, the coil assembly 33 includes a plurality of coils 31 attached to the stator core 32 and arranged along the circumferential direction. The plurality of coils 31 is mounted on the respective teeth of the stator core 32 with corresponding insulators (not illustrated) interposed therebetween. The plurality of coils 31 is disposed along the circumferential direction. In more detail, the plurality of coils 31 is arranged at equal intervals in the circumferential direction all the way around the motor axis J1. Although not illustrated, in the present embodiment, the plurality of coils 31 is star-connected to form an AC circuit of a plurality of phases. The plurality of coils 31 constitutes, for example, a three-phase AC circuit.

The coil assembly 33 includes coil ends 33a and 33b each of which is arranged to protrude in the axial direction from the stator core 32. The coil end 33a is arranged to protrude to the right side (−Y side) from the stator core 32. The coil end 33b is arranged to protrude to the left side (+Y side) from the stator core 32. The coil end 33a includes a portion of each of the coils 31 included in the coil assembly 33 which protrudes to the right side of the stator core 32. The coil end 33b includes a portion of each of the coils 31 included in the coil assembly 33 which protrudes to the left side of the stator core 32. In the present embodiment, the coil ends 33a and 33b constitute an annular shape about the motor axis J1.

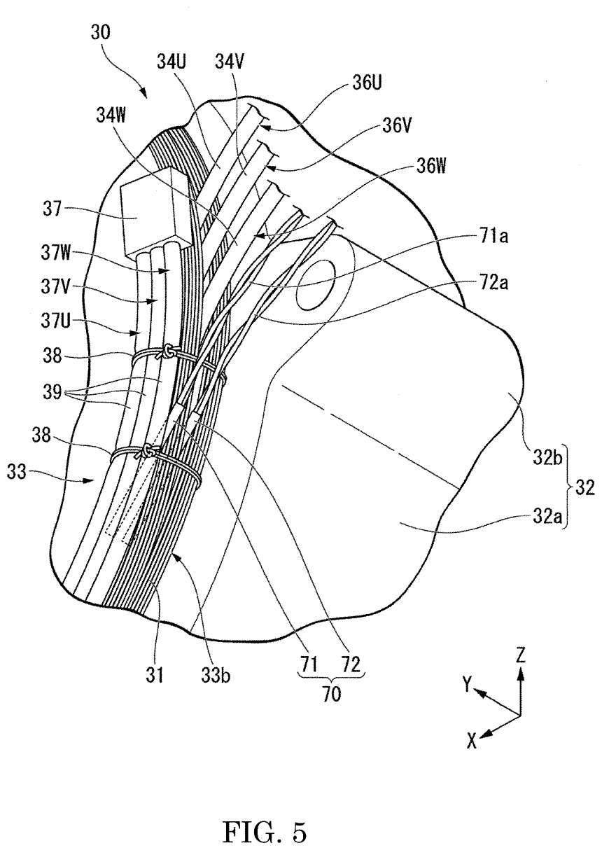

As illustrated in FIG. 5, the coil assembly 33 includes coil lead wires 36U, 36V, 36W, 37U, 37V, and 37W, and a binding member 38. The coil lead wires 36U, 36V, 36W, 37U, 37V, and 37W are drawn out from the coil 31. In the present embodiment, the coil lead wires 36U, 36V, 36W, 37U, 37V, and 37W are a part of the conducting wire constituting the coil 31. Each of the coil lead wires 36U, 36V, 36W, 37U, 37V, and 37W is covered with an insulating tube 39 and is wound around the coil end 33b.

The coil lead wires 36U, 36V, and 36W are coil lead wires electrically connected to the inverter 8c via a first busbar 100 and a second busbar 8d described later. AC currents having different phases flow from the inverter 8c to the coil lead wire 36U, the coil lead wire 36V, and the coil lead wire 36W. A distal end of the coil lead wire 36U is a terminal portion 34U. A distal end of the coil lead wire 36V is a terminal portion 34V. A distal end of the coil lead wire 36W is a terminal portion 34W. That is, the coil assembly 33 has terminal portions 34U, 34V, and 34W.

The terminal portions 34U, 34V, and 34W protrude radially outward from the coil end 33b. In the present embodiment, the terminal portions 34U, 34V, and 34W protrude obliquely upward on the rear side (−X side) from the coil end 33b. As illustrated in FIG. 3, the terminal portions 34U, 34V, and 34W are located on the rear side (−X side) of the motor axis J1 in the front-rear direction. The terminal portions 34U, 34V, and 34W are located above the motor axis J1. The terminal portion 34U, the terminal portion 34V, and the terminal portion 34W are arranged side by side at intervals along the circumferential direction. The terminal portion 34U, the terminal portion 34V, and the terminal portion 34W are electrically connected to the inverter 8c via the first busbar 100 and the second busbar 8d described later. A crimp terminal 34a is provided at each of distal ends of the terminal portions 34U, 34V, and 34W. The terminal portions 34U, 34V, and 34W are electrically connected to the first busbar 100 via the crimp terminal 34a.

As illustrated in FIG. 5, the coil lead wires 37U, 37V, and 37W are coil lead wires whose distal ends are connected to each other via a neutral point member 37. The neutral point member 37 electrically connects the distal end of the coil lead wire 37U, the distal end of the coil lead wire 37V, and the distal end of the coil lead wire 37W as a neutral point. The coil lead wires 37U, 37V, and 37W are wound along the circumferential direction on the left side (+Y side) of the portion of the coil end 33b located on the rear side (−X side) with respect to the motor axis J1. The distal ends of the coil lead wires 37U, 37V, and 37W and the neutral point member 37 are located above the motor axis J1. Note that a plurality of sets of the coil lead wires 37U, 37V, and 37W and the neutral point member 37 may be provided.

The binding member 38 is an annular member that collectively binds the coil lead wires 36U, 36V, 36W, 37U, 37V, and 37W covered with the insulating tube 39 and the coil end 33b. A plurality of the binding members 38 is provided. FIG. 5 illustrates two binding members 38 that bind the coil lead wires 37U, 37V, and 37W and the coil end 33b. The binding member 38 may be, for example, a string or a plastic band.

As illustrated in FIG. 1, the bearings 26 and 27 are arranged to rotatably support the rotor 20. Each of the bearings 26 and 27 is, for example, a ball bearing. The bearing 26 is a bearing arranged to rotatably support a portion of the rotor 20 which is located on the right side (−Y side) of the stator core 32. In the present embodiment, the bearing 26 is arranged to support a portion of the shaft 21 which is located on the right side of a portion of the shaft 21 to which the rotor body 24 is fixed. The bearing 26 is held in a wall portion of the motor housing 81, covering the right side of the rotor 20 and the stator 30.

The bearing 27 is a bearing arranged to rotatably support a portion of the rotor 20 which is located on the left side (+Y side) of the stator core 32. In the present embodiment, the bearing 27 is arranged to support a portion of the shaft 21 which is located on the left side of the portion of the shaft 21 to which the rotor body 24 is fixed. The bearing 27 is held by the partition 61c.

As illustrated in FIG. 4, the motor 2 includes a first busbar 100 and a terminal block 110. That is, the drive device 1 includes the first busbar 100 and the terminal block 110. The first busbar 100 is a busbar to which the terminal portions 34U, 34V, and 34W are connected. In the present embodiment, for example, three first busbars 100 are provided. One ends of the three first busbars 100 are connected to the terminal portions 34U, 34V, and 34W, respectively. The other ends of the three first busbars 100 are connected to respective portions of the three second busbars 8d protruding to the outside of the inverter case 8a.

The terminal block 110 is a member that holds the first busbar 100. The terminal block 110 is arranged to extend in the axial direction. In the present embodiment, the terminal block 110 is supported by a rear (−X side) and the upper portion of the outer circumferential surface of the stator core body 32a. In the present embodiment, the first busbar 100 and the terminal block 110 are provided in a portion located between the stator 30 and the inverter unit 8 in the front-rear direction in the motor housing 81.

As illustrated in FIG. 1, the transmission device 3 is housed in the gear housing 82 of the housing 6. The transmission device 3 is connected to the motor 2. In more detail, the transmission device 3 is connected to the end of the shaft 21 on the left side. The transmission device 3 includes the speed reducer 4 and the differential 5. A torque outputted from the motor 2 is transferred to the differential 5 through the speed reducer 4.

The speed reducer 4 is connected to the motor 2. The speed reducer 4 is arranged to increase the torque outputted from the motor 2 in accordance with a reduction ratio while reducing the rotation speed of the motor 2. The speed reducer 4 is arranged to transfer the torque outputted from the motor 2 to the differential 5. The speed reducer 4 includes the first gear 41, a second gear 42, a third gear 43, and an intermediate shaft 45.

The torque outputted from the motor 2 is transferred to a ring gear 51 of the differential 5 through the shaft 21, the first gear 41, the second gear 42, the intermediate shaft 45, and the third gear 43 in this order.

The differential 5 is connected to the motor 2 through the speed reducer 4. The differential 5 is a device arranged to transfer the torque outputted from the motor 2 to wheels of the vehicle. The differential 5 is arranged to transfer the same torque to axles 55 of left and right wheels while absorbing a difference in speed between the left and right wheels when the vehicle is turning. The differential 5 has the ring gear 51. The ring gear 51 is arranged to rotate about a differential axis J3 parallel to the motor axis J1. The torque outputted from the motor 2 is transferred to the ring gear 51 through the speed reducer 4.

The lower end of the ring gear 51 is located below the oil level Sg of the oil pool P in the gear housing 82. Accordingly, the lower end of the ring gear 51 is immersed in the oil O in the gear housing 82. In the present embodiment, the oil level Sg of the oil pool P is located below the differential axis J3 and the axle 55.

The drive device 1 is provided with the oil passage 90, through which the oil O circulates in the housing 6. The oil passage 90 is a channel of the oil O along which the oil O is fed from the oil pool P to the motor 2 and is led back to the oil pool P. The oil passage 90 is provided across the inside of the motor housing 81 and the inside of the gear housing 82.

Note that the term “oil passage” as used herein refers to a channel of oil. Therefore, the concept of “oil passage” includes not only a “flow passage”, in which a steady flow of an oil in one direction is generated, but also a channel in which the oil is allowed to temporarily stay, and a channel along which the oil drips. Examples of the channel in which the oil is allowed to temporarily stay include a reservoir arranged to store the oil.

The oil passage 90 includes a first oil passage 91 and a second oil passage 92. Each of the first oil passage 91 and the second oil passage 92 is arranged to circulate the oil O in the housing 6. The first oil passage 91 includes a scraping-up channel 91a, a shaft feed channel 91b, an intra-shaft channel 91c, and an intra-rotor channel 91d. The first oil passage 91 is provided in its channel with a first reservoir 93. The first reservoir 93 is provided in the gear housing 82.

The scraping-up channel 91a is a channel along which the oil O is scraped up from the oil pool P by rotation of the ring gear 51 of the differential 5 to be received by the first reservoir 93. The first reservoir 93 is arranged to open upward. The first reservoir 93 receives a portion of the oil O which has been scraped up by the ring gear 51. The first reservoir 93 also receives portions of the oil O which have been scraped up by the second gear 42 and the third gear 43 in addition to the ring gear 51 when, for example, the oil level Sg of the oil pool P is at a high level, e.g., immediately after the motor 2 is started.

The shaft feed channel 91b is arranged to lead the oil O from the first reservoir 93 into the hollow portion 22 of the shaft 21. The intra-shaft channel 91c allows the oil O to flow through the hollow portion 22 of the shaft 21. The intra-rotor channel 91d is a channel along which the oil O passes through the communicating hole 23 of the shaft 21 and an interior of the rotor body 24, and is scattered to the stator 30.

In the intra-shaft channel 91c, a centrifugal force is applied to the oil O in the rotor 20 due to the rotation of the rotor 20. Thus, the oil O is continuously scattered radially outward from the rotor 20. The scattering of the oil O generates a negative pressure in a channel in the rotor 20, causing the oil O accumulated in the first reservoir 93 to be sucked into the rotor 20, so that the channel in the rotor 20 is filled with the oil O.

A portion of the oil O which has reached the stator 30 absorbs heat from the stator 30. The oil O having cooled the stator 30 drips downward to accumulate in a lower region in the motor housing 81. The oil O having accumulated in the lower region in the motor housing 81 moves to the gear housing 82 through the partition opening 68 provided in the partition 61c. In the above-described manner, the first oil passage 91 feeds the oil O to the rotor 20 and the stator 30.

In the second oil passage 92, the oil O is raised from the oil pool P to above the stator 30 to be supplied to the stator 30. That is, in the present embodiment, the drive device 1 includes the second oil passage 92 as an oil passage for supplying the oil O to the stator 30 from above. The second oil passage 92 is provided with an oil pump 96, a cooler 97, and a second reservoir 10. The second oil passage 92 includes a first flow passage 92a, a second flow passage 92b, and a third flow passage 92c.

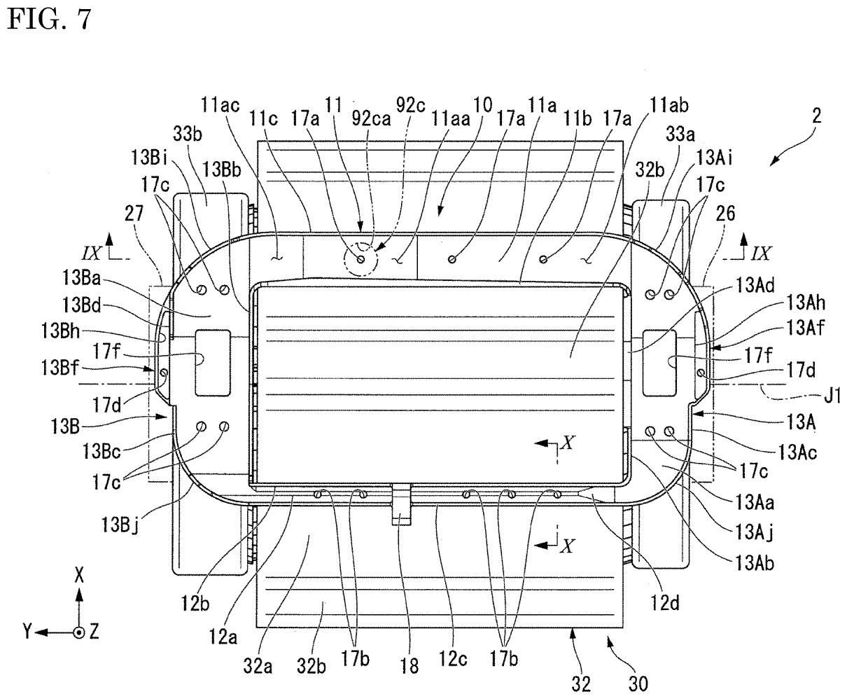

Each of the first flow passage 92a, the second flow passage 92b, and the third flow passage 92c is defined in a wall portion of the housing 6. The first flow passage 92a connects the oil pool P and the oil pump 96. The second flow passage 92b connects the oil pump 96 and the cooler 97. The third flow passage 92c extends upward from the cooler 97. The third flow passage 92c is provided on the wall portion of the motor housing 81. That is, the motor 2 includes the third flow passage 92c. As illustrated in FIGS. 6 and 7, the third flow passage 92c includes a supply port 92ca that opens inside the motor housing 81 above the stator 30. The supply port 92ca supplies the oil O to the inside of the motor housing 81.

The oil pump 96 is an electric pump driven by electricity. As illustrated in FIG. 1, the oil pump 96 sucks up the oil O from the oil pool P through the first flow passage 92a, and supplies the oil O to the motor 2 through the second flow passage 92b, the cooler 97, the third flow passage 92c, and the second reservoir 10.

The cooler 97 cools the oil O passing through the second oil passage 92. The second flow passage 92b and the third flow passage 92c are connected to the cooler 97. The second flow passage 92b and the third flow passage 92c are connected to each other through an internal flow passage of the cooler 97. A cooling water pipe 97j for passing cooling water cooled by a radiator (not illustrated) is connected to the cooler 97. The oil O passing through the inside of the cooler 97 is cooled by heat exchange with the cooling water passing through the cooling water pipe 97j. The inverter unit 8 is provided in the cooling water pipe 97j. The cooling water passing through the cooling water pipe 97j cools the inverter unit 8.

The second reservoir 10 constitutes a part of the second oil passage 92. The second reservoir 10 is located inside the motor housing 81. The second reservoir 10 is located above the stator 30. As illustrated in FIG. 6, the second reservoir 10 is supported by the stator 30 from below, and is provided in the motor 2. The second reservoir 10 is made of, for example, a resin material.

In the following description, for an object, the side closer to the center of the stator 30 in the axial direction may be referred to as “axially inward”, and the side away from the center of the stator 30 in the axial direction may be referred to as “axially outward”.

In the present embodiment, the second reservoir 10 has a gutter shape that opens upward and extends in a substantially rectangular frame shape when viewed in the vertical direction. The second reservoir 10 stores the oil O. In the present embodiment, the second reservoir 10 stores the oil O supplied in the motor housing 81 via the third flow passage 92c. That is, in the present embodiment, the third flow passage 92c corresponds to a supply oil passage that supplies the oil O to the second reservoir 10. In the present embodiment, since the second reservoir 10 has a gutter shape opening upward, the oil O can be easily supplied to the second reservoir 10 by allowing the oil O to flow out of the third flow passage 92c above the second reservoir 10. As illustrated in FIGS. 6 to 8, the second reservoir 10 includes a first oil passage portion 11, a second oil passage portion 12, a pair of third oil passage portions 13A and 13B, a first fixing portion 18, and support ribs 16a and 16b.

The first oil passage portion 11 and the second oil passage portion 12 extend in the axial direction. The first oil passage portion 11 and the second oil passage portion 12 are disposed at an interval in the front-rear direction. As illustrated in FIG. 7, the second oil passage portion 12 and the first oil passage portion 11 sandwich the motor axis J1 when viewed in the vertical direction. The first oil passage portion 11 is located on the front side relative to the motor axis J1. The second oil passage portion 12 is located on the rear side relative to the motor axis J1.

The pair of third oil passage portions 13A and 13B extends in the front-rear direction. The pair of third oil passage portions 13A and 13B is disposed at an interval in the axial direction. The pair of third oil passage portions 13A and 13B connects the first oil passage portion 11 and the second oil passage portion 12. In the present embodiment, one third oil passage portion 13A of the pair of third oil passage portions 13A and 13B connects the right end of the first oil passage portion 11 and the right end of the second oil passage portion 12. In the present embodiment, the other third oil passage portion 13B of the pair of third oil passage portions 13A and 13B connects the left end of the first oil passage portion 11 and the left end of the second oil passage portion 12. The first oil passage portion 11, the second oil passage portion 12, and the pair of third oil passage portions 13A and 13B each have a substantially U-shaped gutter-like cross section that opens upward.

The first oil passage portion 11 is located above the stator core 32. In the present embodiment, the first oil passage portion 11 is located in front of the fixing portion 32b, among the fixing portions 32b, that protrudes upward. The first oil passage portion 11 includes a first bottom wall portion 11a and a pair of first side wall portions 11b and 11c.

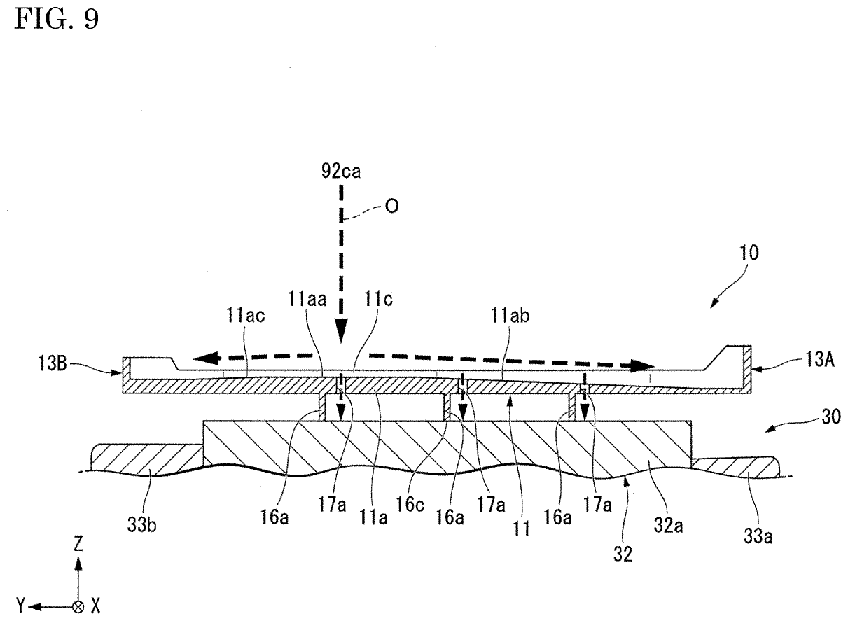

The first bottom wall portion 11a extends in the axial direction. The first bottom wall portion 11a has a plate shape with the plate face oriented in the vertical direction. As illustrated in FIG. 9, the first bottom wall portion 11a faces the outer circumferential surface of the stator core body 32a via a gap. The upper side face of the first bottom wall portion 11a includes a flat portion 11aa and inclined portions 11ab and 11ac.

The first oil passage portion 11 is located below the supply port 92ca. As a result, the first oil passage portion 11 receives the oil O supplied into the motor housing 81 from the supply port 92ca. That is, the third flow passage 92c as a supply oil passage supplies the oil O to a portion of the second reservoir 10 located on the front side (+X side) of the motor axis J1. In the present embodiment, the supply port 92ca is disposed radially inward relative to the axial ends on the opposite sides of the first oil passage portion 11. As illustrated in FIG. 7, the supply port 92ca overlaps with the left portion of the first bottom wall portion 11a when viewed in the vertical direction.

As illustrated in FIGS. 7 to 9, the first oil passage portion 11 includes a first oil supply port 17a for supplying the oil O to the stator 30 from above. In the present embodiment, the first oil supply port 17a is a through hole that penetrates the first bottom wall portion 11a in the vertical direction. The first oil supply port 17a has, for example, a circular shape. The first oil supply port 17a is located above the stator 30. More specifically, the first oil supply port 17a is located above the stator core 32 at a distance. As illustrated in FIG. 9, part of the oil O supplied to the first oil passage portion 11 flows out below the first oil passage portion 11 through the first oil supply port 17a, and is supplied to the stator core 32 from above. Thus, in the present embodiment, the first oil supply port 17a supplies the oil O to the stator core 32 from above.

In the present embodiment, a plurality of the first oil supply ports 17a is provided along the axial direction in which the first oil passage portion 11 extends. In the present embodiment, for example, three first oil supply ports 17a are provided.

As illustrated in FIG. 6, the second oil passage portion 12 is located above the stator core 32. In the present embodiment, the second oil passage portion 12 is located behind the fixing portion 32b, among the fixing portions 32b, that protrudes upward. Therefore, the first oil passage portion 11 and the second oil passage portion 12 are disposed so as to sandwich, in the front-rear direction, the fixing portion 32b, of the fixing portions 32b, which protrudes upward. The dimension of the second oil passage portion 12 in the front-rear direction is smaller than the dimension of the first oil passage portion 11 in the front-rear direction. The lower end of the second oil passage portion 12 is located lower than the lower end of the first oil passage portion 11. The second oil passage portion 12 includes a second bottom wall portion 12a and a pair of second side wall portions 12b and 12c.

The second bottom wall portion 12a includes a front portion 12aa and a rear portion 12ab. The second oil passage portion 12 is provided with the first fixing portion 18. The first fixing portion 18 is provided at a left portion of the second oil passage portion 12 relative to the center in the axial direction. The first fixing portion 18 includes a through hole 18a that penetrates the first fixing portion 18 in the axial direction. Although not illustrated, a screw to be fastened into the motor housing 81 passes through the through hole 18a. The first fixing portion 18 is fixed to the housing 6 by a screw passing through the through hole 18a.

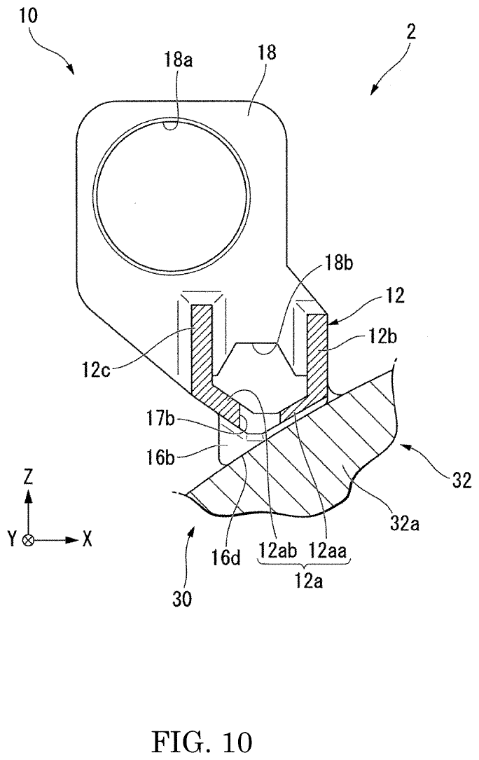

As illustrated in FIG. 10, the lower end of the first fixing portion 18 is connected to the second side wall portion 12b and the second side wall portion 12c so as to be over them. The first fixing portion 18 closes part of the upper opening of the second oil passage portion 12. The lower end of the first fixing portion 18 includes a portion located inside the second oil passage portion 12. A portion, of the first fixing portion 18, located inside the second oil passage portion 12 is provided with a recess portion 18b that is recessed upward. Therefore, in the portion, of the second oil passage portion 12, where the first fixing portion 18 is provided, it is easy to secure the internal flow passage area.

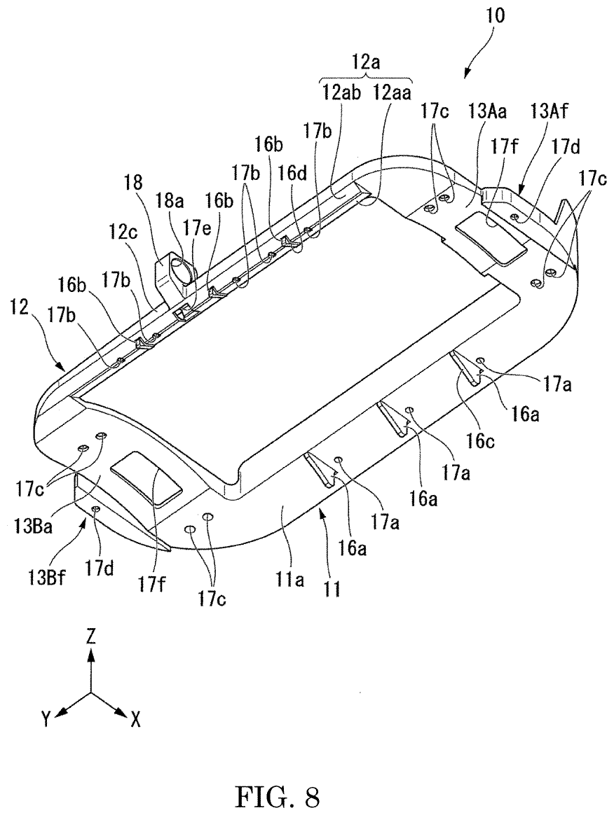

As illustrated in FIGS. 7 and 8, the second oil passage portion 12 includes second oil supply ports 17b and 17e for supplying the oil O to the stator 30 from above. In the present embodiment, the second oil supply ports 17b and 17e are through holes that penetrate the second bottom wall portion 12a in the vertical direction. The second oil supply ports 17b and 17e are provided at a connection portion between the front portion 12aa and the rear portion 12ab. The second oil supply port 17b is, for example, circular shape. The second oil supply port 17e is, for example, rectangular.

The second oil supply ports 17b and 17e are located above the stator 30. More specifically, the second oil supply ports 17b and 17e are located above the stator core 32. At least part of the oil O supplied to the second oil passage portion 12 flows out below the second oil passage portion 12 through the second oil supply ports 17b and 17e, and is supplied to the stator core 32 from above. Thus, in the present embodiment, the second oil supply ports 17b and 17e supply the oil O to the stator core 32 from above.

In the present embodiment, a plurality of the second oil supply ports 17b is provided along the axial direction in which the second oil passage portion 12 extends. In the present embodiment, for example, five second oil supply ports 17b are provided.

As illustrated in FIG. 7, the third oil passage portion 13A is located on the right side of the stator core 32. The third oil passage portion 13A is located above the coil end 33a. The third oil passage portion 13B is located on the left side of the stator core 32. The third oil passage portion 13B is located above the coil end 33b. In the present embodiment, the third oil passage portion 13A and the third oil passage portion 13B have substantially the same configuration except that they are disposed substantially symmetrically in the axial direction. Therefore, in the following description, only the third oil passage portion 13A may be described as a representative of the third oil passage portion 13A and the third oil passage portion 13B.

The third oil passage portion 13A includes a third bottom wall portion 13Aa and a pair of third side wall portions 13Ab and 13Ac. The third bottom wall portion 13Aa extends in the front-rear direction. The third bottom wall portion 13Aa has a plate shape with the plate face oriented in the vertical direction. The front end of the third bottom wall portion 13Aa is connected to the right end of the first bottom wall portion 11a. The rear end of the third bottom wall portion 13Aa is connected to the right end of the second bottom wall portion 12a. As illustrated in FIGS. 6 and 8, a central portion of the third bottom wall portion 13Aa in the front-rear direction is curved in an arc shape that protrudes upward along the outer circumferential surface above the coil end 33a. The rear end of the third bottom wall portion 13Aa is located lower than the front end of the third bottom wall portion 13Aa.

As illustrated in FIG. 6, the third side wall portion 13Ab protrudes upward from an axially inner (left side) edge of the third bottom wall portion 13Aa. The third side wall portion 13Ac protrudes upward from an axially outer (right side) edge of the third bottom wall portion 13Aa. The pair of third side wall portions 13Ab and 13Ac extend in the front-rear direction. The pair of third side wall portions 13Ab and 13Ac has a plate shape with the plate face oriented in the axial direction. The front end of the third side wall portion 13Ab is connected to the right end of the first side wall portion lib. The rear end of the third side wall portion 13Ab is connected to the right end of the second side wall portion 12b.

The third side wall portion 13Ab includes a second fixing portion 13Ad at the center in the front-rear direction. The screw for fixing the stator core 32 to the motor housing 81, together with the stator core 32, fastens and fixes the second fixing portion 13Ad to the motor housing 81. The second reservoir 10 is fixed to the housing 6 by the first fixing portion 18 and the second fixing portion 13Ad being screwed to the motor housing 81. Thereby, the second reservoir 10 can be firmly fixed.

The front end of the third side wall portion 13Ac is connected to the right end of the first side wall portion 11c. The rear end of the third side wall portion 13Ac is connected to the right end of the second side wall portion 12c. The front end of the third side wall portion 13Ac is a bent portion 13Ai that is curved toward and is smoothly connected to the first side wall portion 11c. The rear end of the third side wall portion 13Ac is a bent portion 13Aj that is curved toward and is smoothly connected to the second side wall portion 12c.

The bent portion 13Ai includes a protrusion 13Ae protruding upward. Although not illustrated, the upper end of the protrusion 13Ae is in contact with, for example, the upper face of the inner wall face of the motor housing 81. As a result, the oil O flowing into the third oil passage portion 13A can be prevented from flowing over the bent portion 13Ai, and the oil O can be prevented from leaking from the third oil passage portion 13A.

As illustrated in FIGS. 7 and 8, the third oil passage portion 13A includes third oil supply ports 17c and 17f for supplying the oil O to the stator 30 from above. In the present embodiment, the third oil supply ports 17c and 17f are through holes that penetrate the third bottom wall portion 13Aa in the vertical direction. The third oil supply port 17c is, for example, circular shape. The third oil supply port 17f is, for example, rectangular elongated in the front-rear direction. The third oil supply ports 17c and 17f are located above the stator 30. More specifically, the third oil supply ports 17c and 17f are located above the coil end 33a. Part of the oil O supplied to the third oil passage portion 13A flows out below the third oil passage portion 13A through the third oil supply ports 17c and 17f, and is supplied to the coil end 33a from above. Thus, in the present embodiment, the third oil supply ports 17c and 17f supply the oil O to the coil end 33a from above.

In the present embodiment, a plurality of the third oil supply ports 17c is provided in the direction in which the third oil passage portion 13A extends, that is, along the front-rear direction. In the present embodiment, for example, four third oil supply ports 17c are provided in the third oil passage portion 13A. More specifically, the third oil passage portion 13A is provided with a total of four third oil supply ports 17c where the third oil supply ports 17c are disposed in two rows in the axial direction with each row having two third oil supply ports 17c disposed at intervals in the front-rear direction.

The third oil supply port 17f is provided between two sets of third oil supply ports 17c arranged at an interval in the front-rear direction. The third oil supply port 17f is provided at the center of the third oil passage portion 13A in the front-rear direction. The third oil supply port 17f extends in the direction in which the third oil passage portion 13A extends, that is, in the front-rear direction. The opening area of the third oil supply port 17f is larger than the opening area of the third oil supply port 17c. The axial dimension of the third oil supply port 17f is twice or more the inner diameter of the third oil supply port 17c. The dimension of the third oil supply port 17f in the front-rear direction is four times or more the inner diameter of the third oil supply port 17c.

As illustrated in FIG. 7, the third oil passage portion 13A includes a bearing oil supply portion 13Af that protrudes axially outward (to the right side). The bearing oil supply portion 13Af is located at the center of the third oil passage portion 13A in the front-rear direction. The bearing oil supply portion 13Af is located above the bearing 26. The bearing oil supply portion 13Af includes a recess groove portion 13Ah and a fifth oil supply port 17d. That is, the second reservoir 10 includes the recess groove portion 13Ah and the fifth oil supply port 17d. The recess groove portion 13Ah is provided on an axially outer edge of the upper side face of the third bottom wall portion 13Aa. The recess groove portion 13Ah is recessed downward and extends in the front-rear direction. The fifth oil supply port 17d is provided on the groove bottom face of the recess groove portion 13Ah. The fifth oil supply port 17d is a through hole that penetrates the third bottom wall portion 13Aa in the vertical direction. The fifth oil supply port 17d is located above the bearing 26. The fifth oil supply port 17d supplies the oil O in the recess groove portion 13Ah to the bearing 26 from above. Therefore, the oil O can be supplied to the bearing 26 via the second reservoir 10 as lubricating oil.

As illustrated in FIG. 6, the third oil passage portion 13B includes a third bottom wall portion 13Ba and a pair of third side wall portions 13Bb and 13Bc. The third side wall portion 13Bb does not include the second fixing portion 13Ad unlike the third side wall portion 13Ab. The front end of the third side wall portion 13Bc is a bent portion 13Bi that is curved toward and is smoothly connected to the first side wall portion 11c. The rear end of the third side wall portion 13Bc is a bent portion 13Bj that is curved toward and is smoothly connected to the second side wall portion 12c. The bent portion 13Bi includes a protrusion 13Be protruding upward. The upper end of the protrusion 13Be is located lower than the upper end of the protrusion 13Ae.

The third oil passage portion 13B includes a bearing oil supply portion 13Bf. As illustrated in FIG. 7, the bearing oil supply portion 13Bf includes a recess groove portion 13Bh and the fifth oil supply port 17d. The fifth oil supply port 17d of the bearing oil supply portion 13Bf supplies the oil O to the bearing 27 from above.

Therefore, the oil O can be supplied to the bearing 27 via the second reservoir 10 as lubricating oil. The third oil passage portion 13B includes a plurality of the third oil supply ports 17c and 17f, as in the third oil passage portion 13A. The third oil supply ports 17c and 17f provided in the third oil passage portion 13B supply the oil O to the coil end 33b from above.

As illustrated in FIGS. 6 and 7, the third oil passage portion 13B includes a guide wall portion 13Bd. The guide wall portion 13Bd protrudes upward from the upper side face of the third bottom wall portion 13Ba. More specifically, the guide wall portion 13Bd protrudes upward from the axially inner (right side) edge of the recess groove portion 13Bh of the upper side face of the third bottom wall portion 13Ba. The guide wall portion 13Bd linearly extends rearward from the bent portion 13Bi. As illustrated in FIG. 7, the rear end of the guide wall portion 13Bd is located on the front side relative to the fifth oil supply port 17d of the bearing oil supply portion 13Bf. The guide wall portion 13Bd guides the oil O flowing from the first oil passage portion 11 to the third oil passage portion 13B to the rear side.

As illustrated by the dashed arrows in FIGS. 6 and 9, the oil O supplied from the third flow passage 92c to the first oil passage portion 11 via the supply port 92ca branches off on both sides of the first oil passage portion 11 in the longitudinal direction, that is, on both sides in the axial direction. More specifically, the oil O supplied to the flat portion 11aa from the supply port 92ca flows along the inclined portions 11ab and 11ac located on both sides of the flat portion 11aa in the axial direction. Since the inclined portions 11ab and 11ac become lower as going away from the flat portion 11aa in the axial direction, the oil O supplied to the flat portion 11aa can be suitably caused to flow in both axial directions along the inclined portions 11ab and 11ac.

Part of the oil O supplied to the first oil passage portion 11 is supplied to the stator core 32 from above via the first oil supply port 17a. Another part of the oil O supplied to the first oil passage portion 11 flows into the third oil passage portions 13A and 13B.

Part of the oil O flowing into the third oil passage portions 13A and 13B is supplied to the coil ends 33a and 33b from above via the third oil supply ports 17c and 17f. Another part of the oil O flowing into the third oil passage portions 13A and 13B flows into the recess groove portions 13Ah, 13Bh, and is supplied to the bearings 26 and 27 from above via the fifth oil supply port 17d. Still another part of the oil O flowing into the third oil passage portions 13A and 13B flows into the second oil passage portion 12 from both sides in the axial direction.

Here, an inclined face 12d that becomes lower as going leftward is provided at the right end of the second bottom wall portion 12a. Therefore, the oil O flowing into the second oil passage portion 12 from the rear end of the third oil passage portion 13A can flow along the inclined face 12d. This makes it easy for the oil O in the third oil passage portion 13A to flow into the second oil passage portion 12.

Further, the third oil passage portion 13B is provided with the guide wall portion 13Bd for guiding the oil O flowing from the first oil passage portion 11 to the third oil passage portion 13B to the rear side. For this reason, the oil O that has flowed into the third oil passage portion 13B easily flows in the front-rear direction along the third oil passage portion 13B, and the oil O easily flows from the third oil passage portion 13B to the second oil passage portion 12.

The oil O flowing into the second oil passage portion 12 flows inward in the axial direction from each of the third oil passage portions 13A and 13B. The oil O flowing into the second oil passage portion 12 is supplied to the stator core 32 from above through the second oil supply ports 17b and 17e.

The oil O supplied from the second reservoir 10 to the stator 30 and the bearings 26 and 27 is dripped downward and accumulates in a lower region in the motor housing 81. The oil O having accumulated in the lower region in the motor housing 81 moves to the gear housing 82 through the partition opening 68 provided in the partition 61c. As described above, the second oil passage 92 supplies the oil O to the stator 30 and the bearings 26 and 27.

The third oil passage portion 13A connects the right end of the first oil passage portion 11 and the right end of the second oil passage portion 12, and the third oil passage portion 13B connects the left end of the first oil passage portion 11 and the left end of the second oil passage portion 12. Therefore, the shape of the second reservoir 10 can be made to be a substantially rectangular frame shape. This facilitates the flow of the oil O in the first oil passage portion 11 to the second oil passage portion 12, and facilitates the flow of the oil O in the entire second reservoir 10.

As illustrated in FIG. 3, the drive device 1 includes a temperature sensor 70 capable of detecting the temperature of the motor 2. The type of the temperature sensor 70 is not particularly limited as long as the temperature of the motor 2 can be detected. The temperature of the motor 2 includes the temperature of the stator 30. In the present embodiment, the temperature sensor 70 can detect the temperature of the stator 30. The temperature sensor 70 has, for example, a rod shape extending in one direction. In the present embodiment, the temperature sensor 70 extends obliquely in a direction slightly inclined in the front-rear direction with respect to the vertical direction.

The temperature sensor 70 is provided in a portion of the coil assembly 33 located on the rear side (−X side) of the motor axis J1. In the present embodiment, the temperature sensor 70 is provided in a portion of the coil assembly 33 located on the rear side of the shaft 21. The temperature sensor 70 is located between the shaft 21 and the inverter unit 8 in the front-rear direction. In the present embodiment, the temperature sensor 70 is provided at the coil end 33b. More specifically, at least a part of the temperature sensor 70 is embedded in the coil end 33b. Therefore, for example, by inserting the temperature sensor 70 into the coil end 33b and embedding at least a part thereof, the temperature sensor 70 can be easily held with respect to the coil end 33b. In the present embodiment, the temperature sensor 70 is inserted into the coil end 33b and substantially entirely embedded in the coil end 33b.

The temperature sensor 70 is located below the terminal portions 34U, 34V, and 34W and above the lower end of the rotor 20, that is, above the lower end of the rotor body 24. Here, the oil level Sm of the oil O stored in the motor housing 81 is located below the lower end of the rotor 20. Therefore, in the present embodiment, the temperature sensor 70 is located above the oil level Sm of the oil O. The temperature sensor 70 is located below the first busbar 100 and the terminal block 110.

As illustrated in FIG. 5, the temperature sensor 70 is provided in a portion of the coil end 33b bound by the binding member 38, and is pressed from the axial direction by the coil lead wires 37U, 37V, and 37W covered with the insulating tube 39. Therefore, it is possible to suitably suppress the temperature sensor 70 from being detached from the coil end 33b. In the present embodiment, the temperature sensor 70 is inserted into and held by the coil end 33b. Therefore, the coil lead wires 37U, 37V, and 37W bound by the binding member 38 press the temperature sensor 70 from the left side (+Y side) via the portions of the coil end 33b located between the coil lead wires 37U, 37V, and 37W and the temperature sensor 70 in the axial direction. In FIG. 5, the temperature sensor 70 passes through the inside of one of the two binding members 38. The temperature sensor 70 may pass through the inside of the two binding members 38. Further, the temperature sensor 70 may be disposed in contact with the end of the coil end 33b in the left-right direction and fixed to the coil end 33b by the binding member 38. That is, it is also possible to adopt a configuration in which the temperature sensor 70 is not inserted into the coil end 33b. In this configuration, it is possible to suppress an increase in the number of assembling steps of the temperature sensor 70.

In the present embodiment, a plurality of temperature sensors 70 is provided. In the present embodiment, two temperature sensors 70, a first temperature sensor 71 and a second temperature sensor 72, are provided. Both the first temperature sensor 71 and the second temperature sensor 72 are provided only in one coil end 33b of the two coil ends 33a and 33b. As a result, it is possible to suppress an increase in the number of assembling steps of the temperature sensor 70 as compared with a configuration in which the temperature sensor 70 is provided in each of the two coil ends 33a and 33b. As illustrated in FIG. 3, the first temperature sensor 71 and the second temperature sensor 72 are arranged in parallel to each other, for example, in the front-rear direction.

The detection result of the first temperature sensor 71 is sent to the control unit 8b via a cable 71a extending from the first temperature sensor 71. The detection result of the second temperature sensor 72 is sent to the control unit 8b via a cable 72a extending from the second temperature sensor 72. The cables 71a and 72a extend upward from the first temperature sensor 71 and the second temperature sensor 72, respectively, and are drawn along the outer circumferential surface of the coil end 33b, for example.

For example, in a case where the drive of the drive device 1 is controlled on the basis of the temperature of the motor 2, it is required that the temperature of the motor 2 can be accurately detected. The control of the drive device 1 based on the temperature of the motor 2 includes, for example, flow rate control of the oil O sent to the motor 2 by the oil pump 96. For example, when the temperature of the motor 2 is higher than a predetermined temperature, the control unit 8b decreases the temperature of the motor 2 by increasing the flow rate of the oil O sent from the oil pump 96 to the motor 2. As a result, it is possible to suppress the temperature of the motor 2 from becoming too high, and it is possible to suppress the occurrence of a defect in the drive device 1.

Here, since the temperature of the motor 2 varies depending on the portion of the motor 2, the detected temperature varies depending on which portion of the motor 2 the temperature is detected. When the drive device 1 is controlled based on the temperature of the motor 2, it is preferable to detect the highest temperature of the motor 2. This is because, for example, the motor 2 can be suitably cooled when the flow rate of the oil pump 96 is controlled to adjust the degree of cooling of the motor 2 as described above.

As the flow rate control of the oil O, for example, the control unit 8b compares the values of the detection results of the first temperature sensor 71 and the second temperature sensor 72. Next, the control unit 8b calculates a drive signal for driving the oil pump 96 on the basis of a detection result of a high value as a result of the comparison, and outputs the drive signal to the oil pump 96. Note that the control unit 8b determines that the detection result of the other temperature sensor 70 has a higher value than the detection signal of the temperature sensor 70 in a case of failure, disconnection, or the like of one temperature sensor 70 when comparing the detection signals of the temperature sensors 70. The control unit 8b increases the value of the drive signal as the value of the detection result of the temperature sensor 70 used to calculate the drive signal increases. That is, the control unit 8b increases the amount of the oil O sent by the oil pump 96 and increases the supply amount of the oil O to the stator 30 as the temperature of the motor 2 is higher. For example, the control unit 8b performs the above-described flow rate control of the oil O at a constant cycle.

In the motor 2, the temperature of the coil 31 serving as a heat source is the highest. However, since the temperature of the coil 31 also varies depending on the portion of the coil 31, the highest temperature in the motor 2 may not be detected only by detecting the temperature of the coil 31. Therefore, in order to detect the highest temperature in the motor 2, it is necessary to provide the temperature sensor 70 in the portion having the highest temperature in the coil 31.

In the present embodiment, the oil O is supplied to the stator 30 from above by the second oil passage 92. Therefore, in the portion to which the oil O is supplied, the temperature of the coil 31 tends to be relatively low. However, in the portion of the coil 31 located on the side on which the terminal portions 34U, 34V, and 34W are provided in the front-rear direction, the oil O is blocked by the terminal portions 34U, 34V, and 34W and the coil lead wires gathering around the terminal portions 34U, 34V, and 34W, and the oil O hardly flows below the terminal portions 34U, 34V, and 34W. Therefore, a portion of the coil 31 located on the rear side (−X side) where the terminal portions 34U, 34V, and 34W are provided and located below the terminal portions 34U, 34V, and 34W is likely to have a relatively high temperature.

On the other hand, the oil O is stored inside the motor housing 81. Therefore, the lower portion of the coil 31 immersed in the oil O is cooled by the oil O, and the temperature tends to be relatively low. Therefore, in the coil 31, on the rear side (−X side) where the terminal portions 34U, 34V, and 34W are provided, the portion located below the terminal portions 34U, 34V, and 34W and above the lower portion immersed in the oil O is likely to have the highest temperature.

To take a measure for this, according to the present embodiment, the temperature sensor 70 capable of detecting the temperature of the motor 2 is provided in the portion of the coil assembly 33 located on the rear side (−X side) of the motor axis J1, and is located below the terminal portions 34U, 34V, and 34W and above the lower end of the rotor 20. Therefore, the temperature sensor 70 is easily provided in a portion where the temperature is most likely to be high in the coil 31 described above. As a result, the temperature sensor 70 can easily detect the highest temperature among the temperatures of the coil 31. Therefore, according to the present embodiment, it is easy to accurately detect the highest temperature among the temperatures of the motor 2 in the drive device 1. As a result, the motor 2 can be suitably cooled when the flow rate of the oil O sent from the oil pump 96 to the motor 2 is controlled based on the temperature of the motor 2 as described above. Therefore, it is possible to appropriately cool the motor 2 and drive the drive device 1 with high energy efficiency.

In the configuration in which the maximum temperature of the motor 2 cannot be accurately detected, even when the maximum temperature of the motor 2 is actually low, it is difficult to reduce the supply amount of the oil O to the stator 30 since the stator 30 is suppressed from becoming high temperature. To take a measure for this, in the present embodiment, the control unit 8b controls the supply amount of the oil O to the stator 30 on the basis of the highest temperature of the motor 2 accurately detected. Therefore, the control unit 8b can reduce the amount of the oil O flowing to the motor housing 81 when the maximum temperature of the motor 2 is low. Therefore, it is possible to suppress an increase in the oil level Sm of the oil O stored in the motor housing 81, and eventually, it is possible to suppress the oil O from becoming a resistance of the rotor 20.

According to the present embodiment, the temperature sensor 70 is located above the oil level Sm of the oil O stored in the motor housing 81. Therefore, the temperature sensor 70 can be more suitably provided in the portion where the temperature is most likely to be high in the coil 31 described above. As a result, the temperature sensor 70 can more accurately detect the highest temperature among the temperatures of the motor 2.

According to the present embodiment, the temperature sensor 70 is provided at the coil end 33b. Therefore, the temperature sensor 70 can be brought into direct contact with the coil 31. As a result, the temperature of the coil 31 can be more suitably detected by the temperature sensor 70. Therefore, the temperature sensor 70 can more accurately detect the highest temperature among the temperatures of the motor 2.

According to the present embodiment, at least a part of the temperature sensor 70 is embedded in the coil end 33b. Therefore, the temperature sensor 70 can be brought into close contact with the coil 31, and the temperature of the coil 31 can be more suitably detected by the temperature sensor 70. Therefore, the temperature sensor 70 can more accurately detect the highest temperature among the temperatures of the motor 2. In addition, it is easy to hold the temperature sensor 70 in the coil assembly 33.

Further, according to the present embodiment, the inverter unit 8 is located on the rear side (−X side) of the motor housing 81. Therefore, the rear portion of the motor housing 81 is covered with the inverter unit 8, and the temperature inside the motor housing 81 is hardly released from the rear portion of the motor housing 81. As a result, heat is easily confined in the rear portion in the motor housing 81. Therefore, the rear portion of the coil assembly 33 housed in the motor housing 81 is likely to have a higher temperature. Therefore, in the rear portion of the coil 31, a portion located below the terminal portions 34U, 34V, and 34W and above the lower portion immersed in the oil O tends to be a portion having the highest temperature in the coil 31. As a result, the temperature sensor 70 can more accurately detect the highest temperature among the temperatures of the motor 2.

The portion in the motor housing 81 between the shaft 21 and the inverter unit 8 in the front-rear direction is substantially the center of the motor housing 81 in the vertical direction. Therefore, heat is particularly easily confined in a portion between the shaft 21 and the inverter unit 8 in the front-rear direction in the motor housing 81. As a result, a portion of the coil 31 located between the shaft 21 and the inverter unit 8 in the front-rear direction tends to be a portion having the highest temperature in the coil 31. To take a measure for this, according to the present embodiment, the temperature sensor 70 is located between the shaft 21 and the inverter unit 8 in the front-rear direction. Therefore, the temperature sensor 70 can more easily detect the temperature of the portion having the highest temperature in the coil 31. Therefore, the temperature sensor 70 can more accurately detect the highest temperature among the temperatures of the motor 2.

In addition, when the temperature sensor 70 is located between the shaft 21 and the inverter unit 8 in the front-rear direction, the distance between the temperature sensor 70 and the terminal portions 34U, 34V, and 34W tends to be short. The coil lead wires are likely to concentrate around the terminal portions 34U, 34V, and 34W, and heat generation is likely to increase. Therefore, since the temperature sensor 70 can be disposed at a position close to the terminal portions 34U, 34V, and 34W, the temperature sensor 70 can more accurately detect the highest temperature among the temperatures of the motor 2.

According to the present embodiment, the first busbar 100 and the terminal block 110 are provided in a portion located between the stator 30 and the inverter unit 8 in the front-rear direction in the motor housing 81.

Therefore, the oil O supplied from the upper side to the stator 30 is easily blocked by the terminal block 110 and the first busbar 100, and the oil O hardly flows to the lower side of the first busbar 100 and the terminal block 110. As a result, the temperature of the portion of the coil 31 located below the first busbar 100 and the terminal block 110 is likely to be the highest temperature of the coil 31. To take a measure for this, in the present embodiment, the temperature sensor 70 is located below the terminal block 110 and the first busbar 100. Therefore, the temperature sensor 70 can more easily detect the temperature of the portion having the highest temperature in the coil 31. Therefore, the temperature sensor 70 can more accurately detect the highest temperature among the temperatures of the motor 2.

According to the present embodiment, the third flow passage 92c as a supply oil passage supplies the oil O to the portion of the second reservoir 10 located on the front side (+X side) of the motor axis J1. That is, the third flow passage 92c supplies the oil O to a portion of the second reservoir 10 located on the side opposite to the side where the terminal portions 34U, 34V, and 34W are provided with respect to the motor axis J1. Therefore, the oil O is less likely to be supplied to the portion of the coil 31 located on the rear side (−X side) with respect to the motor axis J1. As a result, a portion located below the terminal portions 34U, 34V, and 34W in the rear portion of the coil 31 is likely to be a portion having the highest temperature in the coil 31. Therefore, the temperature sensor 70 can more accurately detect the highest temperature among the temperatures of the motor 2.

In addition, according to the present embodiment, the plurality of temperature sensors 70 is provided in the portion of the coil assembly 33 located behind the motor axis J1, and is located below the terminal portions 34U, 34V, and 34W and above the lower end of the rotor 20. Therefore, the plurality of temperature sensors 70 can more suitably and accurately detect the highest temperature among the temperatures of the motor 2. As a result, the control of the drive device 1 by the control unit 8b can be more suitably performed.

In the present embodiment, the control unit 8b adopts, for example, a detection result of the temperature sensor 70 that has detected a high temperature among the first temperature sensor 71 and the second temperature sensor 72. In the present embodiment, the control unit 8b uses the higher value of the detection results of the first temperature sensor 71 and the second temperature sensor 72 when controlling the flow rate of the oil O. According to this, the maximum temperature of the motor 2 can be obtained with higher accuracy, and the drive device 1 can be suitably controlled based on the temperature of the motor 2 obtained with higher accuracy. In addition, for example, even when a failure occurs in one of the first temperature sensor 71 and the second temperature sensor 72, the control of the drive device 1 can be suitably continued by using the other of the first temperature sensor 71 and the second temperature sensor 72.

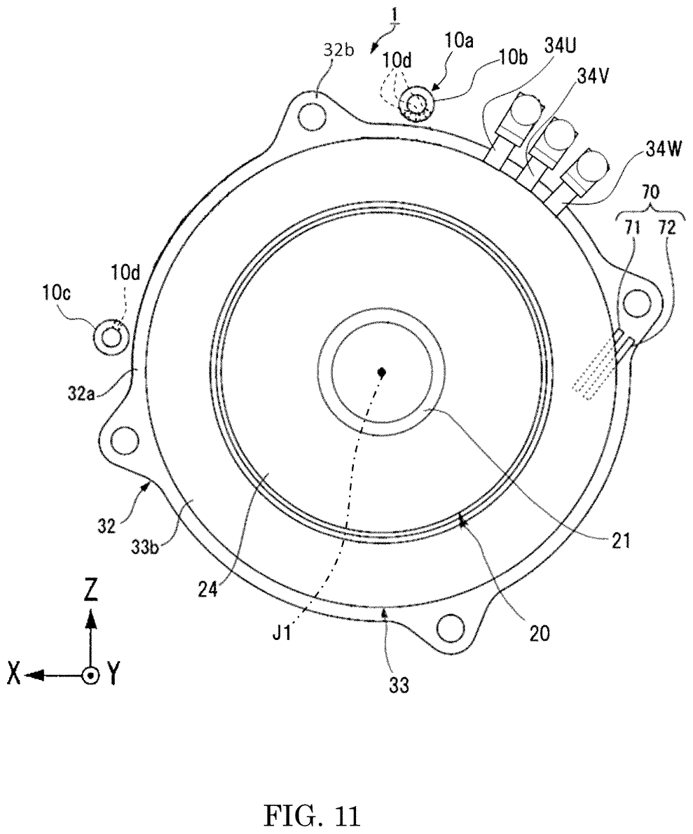

The present invention is not limited to the above-described embodiment, and other structures may be employed. In the first modification illustrated in FIG. 11, the drive device 1 includes a pipe 10a instead of the second reservoir. The pipe 10a has a tubular shape extending in one direction, and unlike the second reservoir, the upper side is not opened. An injection hole 10d opened toward the stator 30 is formed in the pipe 10a. The pipe 10a is housed and fixed in the motor housing 81.

The drive device 1 is provided with, as the pipe 10a, a first pipe 10b disposed above the stator 30 and a second pipe 10c disposed on the front side of the stator 30. Each pipe 10a extends in the left-right direction (Y axis direction), and has a right end opened and a left end closed. Each of the pipes 10a is connected to the third flow passage 92c at the right end on the upstream side. In the third flow passage 92c, a channel connected to the cooler 97 on the upstream side is branched on the downstream side, and the branched channels are connected to the first pipe 10b and the second pipe 10c, respectively. The oil O is supplied from the third flow passage 92c to each pipe 10a, then flows leftward in the pipe 10a, and is injected from each injection hole 10d to the stator 30.

The first pipe 10b is disposed above the terminal portions 34U, 34V, and 34W. More specifically, the opening of the injection hole 10d of the first pipe 10b is located above at least a part of the terminal portions 34U, 34V, and 34W. In the circumferential direction, the first pipe 10b is disposed on the side opposite to the sensor with respect to the terminal portions 34U, 34V, and 34W.

A plurality of injection holes 10d is formed in each pipe 10a. The injection hole 10d of the first pipe 10b opens toward the stator core 32 and the coil ends 33a and 33b. At least one of the injection holes 10d opening toward the coil end 33b of the first pipe 10b also opens to the terminal portions 34U, 34V, and 34W. The injection hole 10d of the second pipe 10c opens only toward the stator 33 and does not open to the coil ends 33a and 33b.

In the first modification, the oil O is injected in the opening direction of the injection hole 10d regardless of the inclination angle of the drive device 1. Therefore, even when the drive device 1 is inclined, the oil O is easily injected to a desired place in the stator 32. According to this, it is possible to suppress the oil O from being injected to an unintended place at the time of inclination of the drive device 1, and it is possible to improve the cooling efficiency of the stator 30.

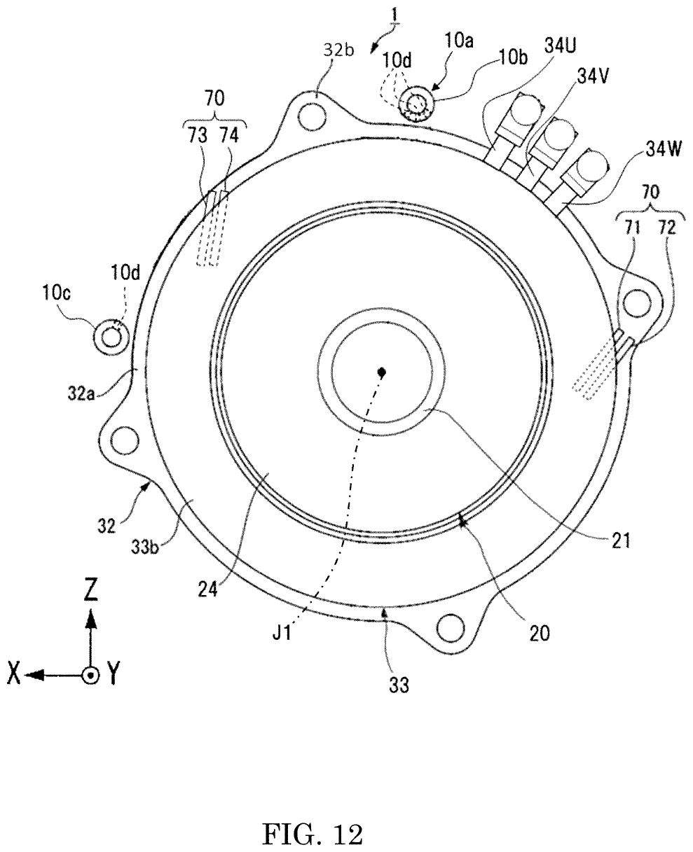

In a second modification illustrated in FIG. 12, temperature sensors 73 and 74 are provided in addition to the temperature sensors 71 and 72. Similarly to the present embodiment, the temperature sensors 71 and 72 are provided on one side of the coil assembly 33 in a predetermined direction orthogonal to both the axial direction and the vertical direction with respect to the motor axis J1. To take a measure for this, the temperature sensors 73 and 74 are provided on the other side of the coil assembly 33 in the predetermined direction with respect to the motor axis J1, that is, on the side opposite to the temperature sensors 71 and 72. In this example, in the coil end 33b, the temperature sensors 71 and 72 are provided on the rear side with respect to the motor axis J1, and the temperature sensors 73 and 74 are provided on the front side with respect to the motor axis J1. The first pipe 10a is disposed on the rear side with respect to the motor axis J1. In the second modification, similarly to the first modification, the injection hole of the second pipe 10c is not opened in the coil end 33b. The four temperature sensors 70 are connected to the control unit 8b, and detection results are sent to the control unit 8b. The control unit 8b controls the flow rate sent by the oil pump 96 based on the highest value among the detection results of the four temperature sensors 70.

Depending on the inclination angle of the drive device 1, the supply position and the supply direction of the oil O from the reservoir or the pipe to the stator 30, it may be difficult to supply the oil O to both sides of the stator 30 in the front-rear direction. In the configuration of the second modification in which the first pipe 10b is disposed on the rear side with respect to the motor axis J1, the oil O is hardly supplied to the front portion of the coil end 33b. For this configuration in the second modification, since the temperature sensors 73 and 74 are also disposed on the front side, the temperatures on both sides in the front-rear direction of the coil end 33b can be measured. Therefore, even when the front side of the coil end 33b has higher temperature than the rear side, the maximum temperature of the motor 2 can be obtained with higher accuracy, and the drive device 1 can be suitably controlled based on the temperature of the motor 2 obtained with higher accuracy.

In the present embodiment, an example in which a plurality of temperature sensors is provided at one coil end has been described, but the present invention is not limited thereto. A configuration in which a temperature sensor is provided in each of both coil ends can also be adopted. The temperature sensor may be provided at any place as long as the temperature sensor is provided at a portion of the coil assembly located behind the motor axis, and is located below the terminal portion and above the lower end of the rotor. The temperature sensor may be provided on a coil lead wire of the coil assembly. The plurality of temperature sensors may be provided at different positions in the vertical direction. The plurality of temperature sensors may be different types of temperature sensors. The number of temperature sensors may be one or three or more.

Features as described above in the present specification may be combined appropriately as long as no conflict arises.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A drive device that rotates an axle of a vehicle, the drive device comprising:
a motor including a rotor rotatable about a motor axis extending in a direction orthogonal to a vertical direction and a stator surrounding the rotor;
a housing having a motor housing that houses the motor therein;
a temperature sensor capable of detecting a temperature of the motor; and
an oil passage that supplies oil to the stator from above in the vertical direction in the motor housing, wherein
the stator includes:
a stator core; and
a coil assembly having a plurality of coils attached to the stator core,
the coil assembly includes a terminal portion located on one side of the motor axis in a predetermined direction orthogonal to both an axial direction and a vertical direction of the motor axis, and
the temperature sensor is provided in a portion of the coil assembly located on one side in the predetermined direction with respect to the motor axis, and is located on a lower side in the vertical direction with respect to the terminal portion and on an upper side in the vertical direction with respect to an end on a lower side in the vertical direction of the rotor.

2. The drive device according to claim 1, wherein the temperature sensor is located on an upper side in the vertical direction with respect to an oil level of oil stored in the motor housing.

3. The drive device according to claim 1, wherein
the coil assembly includes a coil end protruding from the stator core in an axial direction of the motor axis, and
the temperature sensor is provided at the coil end.

4. The drive device according to claim 3, wherein at least a part of the temperature sensor is embedded in the coil end.

5. The drive device according to claim 3, wherein
the coil assembly includes:
a coil lead wire drawn out from the coil and covered with an insulating tube; and
an annular binding member that collectively binds the coil lead wire and the coil end covered with the insulating tube, and
the temperature sensor is provided in a portion of the coil end bound by the binding member, and is pressed from the axial direction by the coil lead wire covered with the insulating tube.

6. The drive device according to claim 1, further comprising
an inverter unit including an inverter that supplies power to the motor, wherein
the terminal portion is electrically connected to the inverter, and
the inverter unit is located on one side of the motor housing portion in the predetermined direction.

7. The drive device according to claim 6, wherein
the rotor includes a shaft centered on the motor axis, and
the temperature sensor is located between the shaft and the inverter unit in the predetermined direction.

8. The drive device according to claim 6 or 7, further comprising:
a busbar to which the terminal portion is connected; and
a terminal block that holds the busbar, wherein
the busbar and the terminal block are provided in a portion located between the stator and the inverter unit in the predetermined direction in the motor housing, and
the temperature sensor is located on a lower side in the vertical direction with respect to the busbar and the terminal block.

9. The drive device according to claim 1, wherein
the oil passage includes:
a reservoir located on an upper side in the vertical direction with respect to the stator and configured to store oil; and
a supply oil passage that supplies oil to the reservoir, and
the supply oil passage supplies oil to a portion of the reservoir located on the other side in the predetermined direction with respect to the motor axis.

10. The drive device according to claim 1, wherein the oil passage includes a pipe which has a tubular shape and in which an injection hole opening toward the stator is formed.

11. The drive device according to claim 1, wherein
a plurality of the temperature sensors is provided, and
the plurality of the temperature sensors is provided in a portion of the coil assembly located on one side in the predetermined direction with respect to the motor axis, and is located on a lower side in the vertical direction with respect to the terminal portion and on an upper side in the vertical direction with respect to an end on a lower side in the vertical direction of the rotor.

12. The drive device according to claim 1, wherein
a plurality of the temperature sensors is provided,
one of the temperature sensors is provided in a portion of the coil assembly located on one side in the predetermined direction with respect to the motor axis, and is located on a lower side in the vertical direction with respect to the terminal portion and on an upper side in the vertical direction with respect to an end on a lower side in the vertical direction of the rotor, and
the other temperature sensor is provided in a portion of the coil assembly located on the other side in the predetermined direction with respect to the motor axis.

13. The drive device according to claim 11 or 12, further comprising:
an oil pump that sends oil to the stator via the oil passage; and
a control unit that controls a flow rate sent by the oil pump, wherein
detection results of the plurality of the temperature sensors are sent to the control unit, and
the control unit controls a flow rate sent by the oil pump based on the detection result indicating a highest temperature among the plurality of detection results.

14. The drive device according to claim 1, further comprising:
an oil pump that sends oil to the stator via the oil passage;
a control unit that controls a flow rate sent by the oil pump; and
a speed reducer connected to the motor, wherein
the housing includes a gear housing that houses the speed reducer,
the oil passage is provided so that oil circulates between the motor housing and the gear housing,
the oil pump is provided in the oil passage and sends oil from the gear housing to the motor housing, and
the control unit controls a flow rate sent by the oil pump based on a detection result of the temperature sensor.
